(19) United States
(12) Patent Application Publication
(10) Pub. No.: US 2007/0278285 A1
(43) Pub. Date: Dec. 6, 2007

(54) Secure Data Management Device and Method

(75) Inventor: Jakob Ehrensvaerd, Taeby (SE)

Correspondence Address: RENNER OTTO BOISSELLE & SKLAR, LLP, 1621 EUCLID AVENUE, NINETEENTH FLOOR, CLEVELAND, OH, 44115, US

(73) Assignee: CYPAK AB, Stockholm (SE)

(21) Appl. No.: 10/598,145

(22) PCT Filed: Feb. 18, 2005
(86) PCT No.: PCT/SE05/00230

§ 371 Date: May 21, 2007

Related U.S. Application Data
(60) Provisional application No. 60/545,870, filed on Feb. 19, 2004.

(51) Int. Cl. G06F 19/00

(52) U.S. Cl. 235/375

(57) ABSTRACT

The invention concerns a secure data management device and a method for providing communication between a remote device in a chain of logistics and a host computer via a data network which ensures the identity, authenticity, integrity and confidentiality of collected information. This is provided by an item which is attached to a product subjected to a chain of logistics. The item can collect information about the product or use of the product and communicates such information to a host computer via a data network in a secure manner, which will assure the recipient of the information that the communication is made with the correct item and that the information communicated has not been manipulated and the transmission is protected from eavesdropping. The information collected by the item can be generated by sensors integrated or attached to the product.

### TECHNICAL FIELD

The invention refers to a secure data management device comprising an electronic module and attached to a product, for collection of generated data and transfer of data from a multitude of distributed products, whereby the data is transferred in a secure way from the electronic module to a host computer via a data network.

### BACKGROUND OF THE INVENTION

Recent developments in microelectronics have reached the point, where it has become technically and commercially feasible to integrate microprocessor-based systems into low cost, disposable items. The development of small, inexpensive sensors and lab-on-chip technologies has also increased the possibilities for making a large number of in-situ analyses and thus generating a lot of geographically spread out data. Sensor systems have also been developed for detecting opening or tampering with packages or disposing of medicaments or other items from special containers. However, little attention has been addressed to basic data security matters in handling the remotely generated data.

Embedding an electronic data collection device into a packaging or the like enables the packaging to become “intelligent” and collect information from external sources and transmit the information via a data network to a database or databases for further evaluation of the information.

In U.S. Pat. No. 6,616,035 a secure transaction between a service provider and a mobile electronic transaction device via a transaction terminal and a computer network is described. The transaction device comprises means for transmitting information to and receiving information from the transaction terminal, data input means, data processing means, data storage means storing an externally accessible device identity, non-retrievable user identification and a non-retrievable secret key and means for supplying electric energy to the device. The secure transaction described comprises authentication of a user holding the card, by the user entering a PIN code on the card and if the code is determined to be correct, the processing means will perform a cryptographic transformation of a transaction using the secret key.

The electronic transaction device can be in the form of a multi-layer plastic card about the size of a credit card or a small calculator and is especially useful for performing transactions and identification in a general form for example for bank cards, club member, fund member or access control cards.

EP 1299788 describes a small portable low-cost card which is capable of storing information related to the holder of the device and to communicate a selection of the information to a requester in a data network via a host computer. The card can carry and communicate a number of single use secret codes to securely authorize or entitle a service from a service provider provided a correct PIN code is entered.

It is also known that packages can be provided with integrated electronics for registering an event affecting the package, such as for example opening the package or dispensing an item out of a blister package. In U.S. Pat. No. 6,244,462 is described a sheet-like envelope of a disposable material and an electric circuit printed onto the envelope and operatively connected to a sensor for detecting dispense of a medicament.

U.S. Pat. No. 6,628,199 shows a response form containing input means which on manual influence can switch a conducting electrical circuit incorporated into the response form for registration of the influence.

In US 2003/00335539 is described a system and a method for electronic distribution of paper-based secure documents to a remote location, in which a specialty paper includes an integral authentication code derived from a RFID. The system allows an intended recipient to print secure data using a home or office desktop printer by having a detector integrated into the desktop printing platform and the detector reads the authenticating code from the specialty paper, which is communicated to a transaction processor. The processor provides a second authentication code and any other secure data pertinent to the transaction, which is communicated back to the requester of the secure document and printed on the specialty paper.

In many applications several concerns arise in terms of data security and integrity. The growth of the Internet and intranets has made it attractive to remotely update and retrieve information from a large number of devices, potentially scattered over a large geographical area. The typical security issues addressed are:

Identity Authentication

To identify a unique item from a host system, each item needs to hold a unique identity. In order to prove the identity, a form of authentication scheme is required to prevent counterfeiting and other identity fraud mechanisms.

Confidentiality

Transmitting information over public networks always involves the risk of eavesdropping. In order to prevent transmitted information from being used by unauthorized, the information needs to be encrypted.

Authenticity

Information being transmitted is vulnerable to different forms of fraudulent modification. By adding a cryptographic checksum, involving a cryptographic operation, a “watermark” is created, which can be used to detect any illegal modification of the data.

Non-Repudiation and Proofing

A more specialized form of authentication involves proofing, where a piece of information needs a digital signature, which can be verified. In order to assure that only the creator of the information should be able to create the signature, but potentially a large number of receivers should be able to verify it. In order to enforce non-repudiation, asymmetric encryption schemes are typically used. Although the above described security issues can be handled by a client computer, retrieving information from the device, that scheme adds some concerns:

Distributing encryption keys to a wide number of users is a major undertaking and possesses threats of keys being compromised.

Invalid keys used by end-users can typically render collected information unusable.

Key management strategies to maintain key integrity in a remote environment are often not practically feasible to implement, nor enforce.

The risk of an unintended (“lack of knowledge”) or indented (“fraud”) key compromise can render the security of the system practically worthless.

Non-repudiation schemes involving digital signatures require a very tight control over the private key in order to fulfill its scope.

The user in possession of a private key may use the private key outside its scope, thereby making the digital signatures worthless.

The user itself may pose a security threat, where data generated by a product, is intentionally manipulated or otherwise unintentionally changed before transmitted to a central server. The incentive to follow strict data security may in some cases be in the interest of one party only.

In summary, a device and method to address the data security issues described above would enable a wider usage and acceptance of intelligent devices and packaging.

### DESCRIPTION OF THE INVENTION

An object of the invention is to provide communication between a remote item in a chain of logistics and a host computer via a data network which ensures the identity, authenticity, integrity and confidentiality of collected information. This is provided by an item which is attached to a product subjected to a chain of logistics. The item can collect information about the product or use of the product and communicate such information to a host computer via a data network in a secure manner, which will assure the recipient of the information that the communication is made with the correct item and that the information communicated has not been manipulated and the transmission is protected from eavesdropping. The information collected by the item can be generated by sensors integrated or attached to the product.

The item or secure data management device can take many forms. It can be an electronic module (EM) integrated into a bearing substrate which can be attached to the product in many different ways, such as adhered to it or the substrate being an integral part of the product or a product enclosure. One important aspect of the attachment of the item to the product is that the item shall be capable of collecting and storing information generated by the sensors.

The item has an integrated electronic module comprising a cryptographic processor enabling identification and authorization of the item and providing for secure transmission of information between the item and a host computer via a computer network and which also provide for enclosing an electronic signature.

The item can be seen as a data collection device for communication with the host computer through a data network. The electronic module have time-keeping means, non-volatile memory means, a device unique identity code, data processing means, cryptographic processing means and data communication means and having sensor means connected to it.

The electronic module includes a unique identity identifying each item individually and a non-retrievable cryptographic key and non-volatile memory for collecting, storing and processing data related to the product or use of the product. The cryptographic key of the item is used for performing a cryptographic process on the collected data exchanged between the item and the host computer. The item can also receive data from the host computer. The cryptographic key is then used for decrypting the information to be stored by the item. The unique identity of the item can be exchanged with the host computer in encrypted form or in clear text depending on the circumstances.

The item can receive data to be stored in the memory before the product to which the item is attached is first sent out. Such pre-stored data can also be exchanged with the host computer in encrypted form or in clear text depending on circumstances.

The item is primarily intended for one-time use, but it may also be an item which can be re-used a limited number of times. The item is advantageously disposable and made of paper or a material comprising one or more paper-layers.

The cryptographic processor must have storage for at least one cryptographic key. The basic requirement of the cryptographic processor is to perform encryption and decryption, using a symmetric algorithm, such as DES, 3DES, AES or similar. In order to fully support the capability of making digital signatures in a Public Key Infrastructure (PKI) setting, the cryptographic processor can also support an asymmetric algorithm, such as RSA, ECC or similar.

The nature of the EM key storage must be “write only”, i.e. the key can be written to the EM, but not retrieved. The key is only used for cryptographic operations and shall be securely stored in a secure storage of the EM. Cryptographic keys should be entered in a secure environment where there is minimum risk for eavesdropping or other ways of compromising the keys.

Additional cryptographic keys can be generated in order to support a third party audition or a later verification of the collected data.

The item could be attached to a product being a package containing goods where authenticity of the goods needs to be checked because of a large inflow on the market of pirating copies of the goods. Or goods that may only be kept under certain conditions, such as a specific temperature interval, which may then be monitored by an integrated sensor and checked without risking fraudulent manipulations of the data. The disposable item can also be a ticket for an event, an admission card or the like where it is beneficial to be able to check the authenticity of the item and information stored on the item. The item can also be useful for collecting information from instruments, sensors or electronic forms that are distributed to many recipients.

The sensors can comprise printed conductive traces which can be printed to form circuits or patches specially adapted for detection of tampering with the item or for detection of a specific event involving the product, like disposing of a medical dose or taking out a component from a compartment of the product.

The sensors can also comprise any type of measuring- or sensing device which is intended to be distributed to a large amount of users, for example a so called “lab-on-chip” for measuring medical data, environmental data, quality control data or hazardous elements.

The product can be a packaging for a drug with inbuilt capacity to register and time-stamp withdrawal of an individual tablet and a response form for direct input of data by the person treated by the tablet. Such products are described in U.S. Pat. Nos. 6,244,462 and 6,628,199, which are hereby integrated into this description. The basic purpose of the microelectronics is to monitor the state of a plurality of printed circuit lines printed onto the packaging material. A change in the resistive properties of a circuit line, signals a possible event that is processed by the EM, where a stable detected event is typically stored in a non-volatile means, together with a time-stamp. A contact-less communication transceiver embedded in the packaging material is used to exchange information with a host computer system. An example of a suitable implementation of a communication interface is described in patent U.S. Pat. No. 6,615,023.

The product could also be an item for which the original producer certification is important, like a watch, handbag or other items which are prone to counterfeiting. It can also be a repair or replacement component where it is of importance to secure that the component is provided by an authorized source. Other examples include products that are sensitive to the handling conditions and where selected properties can be monitored, for example temperature monitoring of transported food.

### DETAILED DESCRIPTION OF THE INVENTION

The below scenario describes an intelligent pharmaceutical packaging that is used to collect clinical data and to ensure that collected data is effectively and securely collected and transferred to a central database holding the clinical trials data. The scenario is likewise applicable to the distribution of many other products in a chain of logistics, where the issuer of the product is interested in collecting information about the product or use of the product which is stored by an item attached to the product and receive the information via a data network in a secure way that verifies that it is the right product communicating the information and that the information has not been manipulated with.
1. A container for pharmaceuticals comprises several parts, one part holds the tablets or the like in a way which makes it possible to automatically register the outtake of an individual tablet, another part includes an electronic module for registration of the outtake together with a corresponding time-stamp. The electronic module is preprogrammed with a unique identity for each module. The container can also include a form for input by the user, which input is registered by the electronic module. The container is packed with the pharmaceutical by an authorized producer and each item is scanned and its unique identity is saved in a database together with a time-stamp.
2. The clinical trial requires the containers to be packed with different types of pharmaceuticals and placebos in a way that unauthorized persons shall not be able to distinguish between different types of content. In this step, each package identity is matched with the dose configuration given and a record is stored in the database together with a time-stamp.
   a. A record of the patients assigned to the various trial containers is stored in the database and matched with one or several of the unique identities of the containers together with a time-stamp. At this stage, the clinical trial containers are sent out and can be said to leave the controlled, or unregulated, environment. Where, from a practical viewpoint, corporate- or regulatory procedures are difficult to implement, enforce and audit. All updates of information in the containers and retrieval of data will be performed over a data network. In this step, at least one cryptographic key K_{A} is generated and sent in clear text to the containers. K_{A} is stored in the memory of the embedded electronic module in the container and can not be retrieved from the electronic module. Further, K_{A} is also stored in the database together with the unique container identity and a time-stamp.
3. Several logistic steps are normally undertaken before the container is handed over to a patient. At a location where it can be meaningful from an auditing point of view, each container can be scanned. At this point, all data is digitally signed and encrypted prior to its retrieval from the container.
4. When a patient receives the container, a check can be performed verifying the identity of the patient with the appropriate patient record stored in the database. A quality assurance test can be performed, where the functionality of the container is tested and the result is sent back to the central database, signed and encrypted. A central approval can then be made that the right package has been deployed to the right patient and that recording of data is functioning properly at the time of deployment.
5. The dispensing of a dose is recorded continually together with the patients' responses to the input form and are stored in the electronic module of the container.
6. The containers are collected after use and scanned. The data sent to the central database is signed and encrypted.
7. The containers can also be sent back to the issuer of the trial and a final scan can verify the chain of events.

An advantage with using a container as described is that it is not possible to retrieve any meaningful information from the package without access to the appropriate key for decryption of the data. A central characteristic of the invention is that the encryption is performed internally in the container itself, thereby protecting the encryption key from illegal or unintended usage. Further, the container itself is a carrier of the encryption key, thus reducing the need for separate distribution of encryption keys. There is also no need for further cryptographic means to be used and the users out in the field do not have to think or care about data security aspects of data transmitted to the centralized database.

Further, in order to strengthen the integrity of the data, the digital signature ensures that data generated by the patient has not been modified anywhere in the chain. Also, the signature, being derived from both the identity and the data, serves as an authentication method for the container identity itself.

It is also possible to have an auditor verifying that the data has not been manipulated from where it was generated to the point where it reaches the centralized clinical trials database.

In order to enable an external auditor to prove the overall clinical trials data generation and storage process, a third-party arbitrator or another “trusted party” can be engaged to further strengthen the data integrity Such a protocol could include the below steps:
a) After (1) above, the containers are sent to a third-party arbitrator, which generates a second encryption key K_{B}, having no relationship to K_{A} above, which is generated and sent in clear text to the container, where it is stored and protected from retrieval. The arbitrator keeps K_{B} in a protected database associated with the clinical trial.
b) After the second key K_{B} has been assigned, each data transfer operation from a container will be signed using this key. It will then be the responsibility of the clinical trials organization to maintain this signature, although the trial organization can not themselves use it to verify integrity of the data. An external auditor can verify a data record from the clinical trial, using the arbitrator to verify the stored signatures.
c) When applicable, a time-stamp generated by the container can be appended to a data record together with a signature generated with key K_{B}. An auditor could then verify time variant events in the audit trail.

In addition, other clinical trials aspects, such as environmental factors, affecting the container and its contents, like temperature, can be monitored and logged. This can also be part of an auditor scheme and for example an auditor can verify the signed temperature span for the container.

By using two different keys, K_{A} and K_{B}, both data security requirements of an issuing organization and auditing requirement of a regulatory body can be fulfilled. The trusted party need not be in possession of K_{A} to be able to verify the signatures generated by K_{B}, thereby effectively splitting the security requirements and responsibilities of the different organizations.

If necessary, it could be possible to implement additional levels of keys, for example where a study sponsor utilizes a third-party clinical trials organization to perform the study. Together with auditing requirements, three different cryptographic keys can be used.

The below described embodiment states a security approach which is made as an integral part of a product itself, and describes necessary enhancements needed to ensure a range of data security issues, when exchanging data between the packaging and a host computer system over an insecure communication channel.

Below is a basic scheme to securely exchange information between a host computer (Host) in a computer network (Network), and an intelligent packaging (Device), for example a product with an attached item. In reality, the intelligent packaging cannot be directly connected to the computer network. This typically occurs through a network-connected terminal, further featuring an interface to exchange data with the intelligent packaging (Reader). In order to simplify the description from a conceptual viewpoint, the details of the “proxy terminal” and interface is omitted in the following text.
1. The device is placed on the reader
2. The device holds an address, typically a Universal Resource Locator (URL) of the host computer. Said URL is used to automatically establish a connection to the host in the computer network.
3. The device transmits its unique identity to the host in clear text. The host performs a search in a database to get the appropriate cryptographic key, used for secure operations with said device.
4. The host issues a random number, which is transmitted to the device as a challenge
5. The device encrypts the challenge, together with its unique identity and sends back the result as a response.
6. The host decrypts the received response and verifies that the result matches the issued challenge and the initial received identity. If the entities match, the device is considered to be authentic.
7. The host requests data from the device, and initiates Chained Block Cipher (CBC) encryption by sending an Initialization Vector (IV). The initialisation vector prevents attempts to replay previously transmitted data
8. The device transmits data to the host, encrypted in CBC mode.
9. The first transmitted block includes a linear counter and a time reference, if applicable, to make two subsequent transmissions for the same data guaranteed different, thereby thwarting attacks involving comparing data.
10. The final block should be a known signature, such as the device identity padded with zeroes, allowing the host to detect that all data has been received successfully
11. The host receives the data en decrypts it. The signature in the last block is verified to ensure that the received data was authentically received and without errors.
12. The host performs necessary operations on the data and returns a suitable completion message to the device
   Depending on security policy, step 4-6 may be considered redundant and therefore be omitted.
   In order to rely on established infrastructure and allow compatibility with typical corporate firewalls, all data may be passed with the HTTP protocol, through a web-browser on the device side and a web-server on the host side. Received data would then typically be stored in hidden fields in a normal HTML form. An additional benefit of passing the data through a web browser is the simplicity and elegance from the user's point of view:
1. The user puts the device on the reader
2. The web browser is automatically launched and the user is informed that data is being transferred
3. When data transfer is complete, the web server issues a completion screen, typically giving a summary of the data received. An additional audiblemessage may be included in the completion HTML form to notify the user that the transfer was successful.
4. The user removes the device from the reader.
5. The Browser is Closed Automatically

Considering an automated scheme like this, interactive products can be supported in a very simple way. Depending on the automated evaluation of the data received, different screens may be presented to the user, such as “There is only one dose left in your packaging. Would you like to order a new one now?” or “The regimen has not been followed properly. Please contact your physician now”.

In order to implement a “zero knowledge protocol”, i.e. avoiding to reveal any information at all, a mutual challenge protocol extension can be implemented as:
1. The unique device identity is not transmitted as clear-text. Instead, the identity is concatenated with a random number and then encrypted with a second-level key, shared with all devices in a given group.
2. A host having a shared key with the device group, will be able to successfully decrypt the data from the device and hereby get the device identity.
3. In order to get more data from the device, the host responds with the decrypted data, where one bit in the challenge has been inverted. The result is again encrypted and passed to the device.
4. The device opens for further communication if the decrypted received data matches the random number issued in step 1, corrected for the inverted bit of step 3.
   Another aspect of the invention, is to use the cryptographic processor to generate digital signatures for data, allowing third-party verification of the data received. In some applications, where the complexity and processing intensive nature of asymmetric signature generations is not feasible, different forms of arbitrated schemes, using less complex symmetric encryption, may be applied.
      Public Key Infrastructure (PKI) Scheme:

Using asymmetric encryption allows generation of qualified digital signatures, with different keys for signature generation and verification. The keys are generally known as “private” for signature generation and “public” for signature verification. The private key is stored in a tamper resistant device and cannot be read-out. The public key is given to all parties involved in verifying the signatures created by the private key.

A typical scheme may look like:
1. A second level key storage is used in the EM. The first key storage is used for decryption of data in the transmission only.
2. An asymmetric key pair is generated. The private key is programmed into the EM as a second key, and should then be discarded. The public key deployed to the party/parties responsible for verification of data.
3. Following the basic scheme described above, an additional signature is generated by the EM using the private key, operating on a condensed part of the information being transmitted. The signature is transmitted to the host
4. The host validates the received asymmetric signature using the public key. The signature may be stored for future reference if there is a dispute over the validity of the data.

It is important to understand the implication of having two different keys stored in the EM, one for confidentiality (and potentially for integrity) and one for creating a legally viable signature.

By including a time reference generated by the EM at time of information retrieval further enables resolution in non-repudiation matters, as each data transmission then implicitly contains a digitally signed time reference.

For applications where asymmetric encryption is not feasible, an arbitrated scheme can be implemented as:
1. A second level key storage is used in the EM. The first key storage is used for decryption of data in the transmission only.
2. A trusted party generates and stores a symmetric key in said key storage.

3. A copy of the key is kept in a secure storage, accessed by the trusted party only.
4. When data is transmitted to the host, the EM performs a symmetric encryption on the final block, using the arbitrator's key
5. The host keeps the arbitrated signature for further reference in case of a dispute. The arbitrator will then verify the authenticity of the signature using its copy of the symmetric key.
   Yet another implementation relying on symmetric encryption could be implemented as:
1. A trusted party generates a symmetric key
2. The key is stored in the key storage of the EM. The EM is programmed to be able to perform encryption only, using said key
3. The trusted party stores a copy of the symmetric key in a tamper resistant device, such as a Smart Card or similar, programmed to allow decryption of data only
4. When data is transmitted to the host, all data is streamed through the tamper resistant device, which returns information in clear text
5. The host verifies that the received signature is authentic and relies on the fact that only the EM can encrypt the information.
6. The arbitrator may not be necessary (and may therefore discard the symmetric key after it has been programmed into the EM and the tamper resistant device), as the host can verify the authenticity of received transaction. However, if the [non rep]

All the protocols described above are described in one direction. From a conceptual viewpoint, the protocols are symmetric, i.e. information transmitted from the host to the device can be secured in the same fashion.

In summary, the device and method implementation details described in the present invention serves the purpose of ensuring several aspects of information security. By storing cryptographic keys in the device itself, both the key distribution and management is solved in a straight-forward manner.

This scheme is not limited to clinical trials. In any logistic operation where many parties are involved and data needs to be secured from an identity, authenticity, confidential and integrity point of view, benefits are gained by performing all security operations within the item being a data carrier and collection device itself.

1. An item, attached to a product which is subjected to a chain of logistics, for collection of data and for communication with a host computer via a data network, the item comprises an electronic module including a unique identity identifying each item individually and a non-retrievable cryptographic key and the host computer is storing the corresponding identity and cryptographic key, characterized by that the electronic module stores collected data related to the product or use of the product in a non-volatile memory and a cryptographic operation is performed on the collected data when exchanged between the item and the host computer in order to ensure identity, authenticity, integrity and confidentiality of the collected data.

2. An item, in accordance with claim 1, characterized by that sensors are applied to the product in a way that the electronic module can receive, store and process data generated by the sensors.

3. An item in accordance with claim 1, characterized by that the electronic module comprises a time-keeping means for generating a time-stamp to be stored together with pre-stored data and the collected data.

4. An item in accordance with claim 1, characterized by that the non-volatile memory holds an address to the host computer for allowing automatic connection to the host computer via the data network.

5. An item in accordance with claim 1, characterized by that the cryptographic key can be supported by a cryptographic processor to perform encryption or decryption using a symmetric algorithm.

6. An item in accordance with claim 1, characterized by that the crypographic key can be supported by a cryptographic processor to perform encryption or decryption using an asymmetric algorithm.

7. An item in accordance with claim 5, characterized by that an additional independent cryptographic key issued by a third party, is stored in the electronic module, the additional key being used to perform at least one cryptographic operation on stored data, in order to enable the third party to use a result of the cryptographic operation to ensure integrity of the stored data.

8. An item in accordance with claim 1, characterized by that the sensors comprise printed conductive traces connected to the electronic module.

9. An item in accordance with claim 8, characterized by that the printed conductive traces are applied in a pattern as to enable detection of disposal of an individually packed element from the product.

10. An item in accordance with claim 9, characterized by that the printed conductive traces are applied in a pattern as to enable detection of attempts to remove the item attached to the product.

11. An item in accordance with claim 1, characterized by that the sensors comprise measurement means for measuring a property like temperature, humidity or chemical elements.

12. A product being a part of a logistic chain and having sensors for measuring a property, characterized by that the product has an item in accordance with claim 1 attached to it.

13. A method for gathering data generated by a multitude of products being part of a logistic chain and each product having an item attached to it, the item comprising an electronic module for communicating with a host computer via a data network and said electronic module comprising a unique identity and a non-retrievable cryptographic key, characterized by that
the generated data is collected and stored by a memory means of the electronic module;
the cryptographic key performs an encryption operation on the generated data;
the generated data is transmitted together with the unique identity to the host computer via a data network;
the host computer is decrypting the transmitted data with a cryptographic key stored in the host computer together with the unique identity given to the item.

14. A method according to claim 13, characterized by that the memory means processes the stored collected data before it is decrypted and transmitted to the host computer.

15. A method according to claim 13, characterized by that the item is provided with data characterizing the product or a user of the product before the product to which the item is attached is sent to a first station of its logistic chain.

16. A method according to claim 13, characterized by that the electronic module receives encrypted data from the host computer when the product is at a station of its logistic chain and the received data is decrypted by the stored cryptographic key and stored in the memory means.

17. A method according to claim 13, characterized by that the electronic module comprises a time keeping means which generates a time stamp each time new data is received by the memory means.

18. A method according to claim 13, characterized by that a third party generates an additional cryptographic key which is stored in a separate data-base and in the electronic module of the item and the additional cryptographic key is used by an auditor to verify the gathered collected data at the host computer.
